(19) United States
(12) Patent Application Publication
(10) Pub. No.: US 2017/0368894 A1
(43) Pub. Date: Dec. 28, 2017

(54) Device for measuring the pressure of a two wheeler tire and a method for monitoring the pressure of a two wheeler tire

(71) Applicant: SKS metaplast Scheffer-Klute GmbH, Sundern (DE)

(72) Inventors: Sven KORDES, Sundern (DE); Karsten GRABSKI, Ense (DE)

(21) Appl. No.: 15/616,622

(22) Filed: Jun. 7, 2017

(30) Foreign Application Priority Data
Jun. 28, 2016 (DE) 10 2016 111 851.6
Jun. 7, 2017 (DE) 10 2016 110 507.4

(51) Int. Cl. B60C 23/04

(52) U.S. Cl. CPC B60C 23/0496; B60C 23/0479

(57) ABSTRACT

A device for measuring the pressure of a two wheeler tire comprises: a connector to connect the device to a valve of the two wheeler tire; a valve opener to open the valve, so that in the connected state with the valve, pressurized air flows out of the two wheeler tire through the valve into the device, until the pressure in the device corresponds to the pressure in the two wheeler tire; a pressure measuring device to measure the pressure in the device; and a transmitter to wirelessly transmit information about the measured pressure. A method for monitoring the pressure of a two wheeler tire includes: determining the actual pressure and desired pressure of the two wheeler tire; comparing the actual and desired pressures; and indicating the actual pressure and/or the desired pressure and/or the difference between the desired and actual pressures of the two wheeler tire.

### TECHNICAL FIELD

The present invention relates to a device for measuring the pressure of a two wheeler tire, in particular, a bicycle tire. Furthermore, the present invention relates to a combination of such a device with a mobile indicating and/or signaling device. Furthermore, the present invention relates to a method for monitoring the pressure of a two wheeler tire, in particular, a bicycle tire.

### BACKGROUND

Bicycles shall be defined as both bicycles without an electric motor and also e-bikes.

For example, it is known from U.S. Pat. No. 5,040,561 to use in motor vehicles tire valves that allow a wireless transmission of information, regarding the tire pressure, to a control unit in the interior of the motor vehicle. The result is that it is possible to indicate or signal to the driver of the motor vehicle whether there is a pressure loss in the tire. The valve, known from the aforesaid US patent, is very large and complicated in design, so that it does not lend itself to use on a bicycle; and, in particular, a bicycle cannot be retrofitted with such a valve. Furthermore, a bicycle is not provided with a built-in control unit that can process and indicate wirelessly transmitted information.

It is known to detect the actual pressure of a tire of two wheeled vehicles, for example, while pumping up, by means of a manometer that is integrated into the air pump.

In a few cases the user knows the standard desired pressure of the tires on his two wheeled vehicle. Then he can pump up the tire, for example, with the air pump, which is equipped with a manometer, until the standard desired pressure is reached. However, it is often the case that the user does not know the standard desired pressure of the tires on his two wheeled vehicle. Furthermore, he is not able to consider the effect of his weight; the weight of the two wheeled vehicle and the load, which is to be transported, in addition; as well as the effect of the route profile of the distance to be covered on the desired pressure.

### SUMMARY

The problem, on which the present invention is based, is to provide a device of the type that is mentioned in the introduction and by means of which information about the pressure of a tire of a two wheeled vehicle, in particular, a bicycle can be transmitted. Furthermore, the object of the invention is to provide a combination of such a device comprising a mobile indicating and/or signaling device that can indicate or signal to the user information about the pressure of a tire. Furthermore, the object of the invention is to provide a method of the type mentioned at the outset, with which a user can monitor more effectively the pressure of a two wheeler tire. Furthermore, the object of the invention is to provide a computing device, on which the method can be carried out, and a computer program, which can cause the computing device to carry out the method.

The above engineering objects are achieved, according to the invention, by means of a device exhibiting the features disclosed in claim 1, a combination exhibiting the features disclosed in claim 6, a method exhibiting the features disclosed in claim 7, a computing device exhibiting the features disclosed in claim 13 and a computer program exhibiting the features disclosed in claim 14. The dependent claims relate to preferred embodiments of the invention.

According to claim 1, the device comprises:

connecting means for the connection of the device to the valve of the two wheeler tire,

means for opening the valve, so that in the connected state with the valve, pressurized air flows out of the two wheeler tire through the valve into the device until the pressure in the device corresponds to the pressure in the two wheeler tire,

pressure measuring means for measuring the pressure in the device,

transmission means for the wireless transmission of the information corresponding to the measured pressure.

When a device of this type is used, there is no need to use a valve that is especially adapted to the transmission. Instead, the device, according to the invention, can be connected to the valve of the tire, where in this case the valve is already mounted on the two wheeled vehicle or, more specifically, the bicycle. Thus, there is the possibility that any two wheeled vehicle or, more specifically, any bicycle can be retrofitted with such devices.

It can be provided that the transmission means are wireless transmission means. The transmission means may be suitable, in particular, for a wireless transmission in accordance with a Bluetooth standard. As a result, it is possible to use, as the indicating and/or signaling device, commercially available smartphones or tablet computers, all of which are usually able to process the transmission of information in accordance with the Bluetooth standard.

There is the possibility that the device has attachment means for an air pump, so that the air pump can be used to pump up the tire of the two wheeled vehicle by means of the device and the valve connected to said device. This arrangement allows the user to have the air pressure shown to him, for example, on his smartphone while he is pumping up the tire. In this way he can have a specific impact on the air pressure.

In this case, for example, the attachment means for the air pump can be disposed on the side of the device that faces away from the connecting means. Thus, the device constitutes in geometric terms only an extension of the valve, so that the user can pump up the tire, as he is used to doing.

It can be provided that the attachment means for the air pump are designed as a bicycle valve, in particular, as a Schrader valve and/or a Sclaverand valve and/or a Dunlop valve. Thus, the tire can be pumped up with commercially available air pumps by means of the device.

There is the possibility that the connecting means comprise a thread for a screw connection of the device to the valve. The result is a tight connection between the device and the valve.

It can be provided that the connecting means are suitable for a connection to Schrader valves and/or Sclaverand valves and/or Dunlop valves. Even the means for opening the valve may be suitable for opening bicycle valves, in particular, Schrader valves and/or Sclaverand valves and/or Dunlop valves. This feature allows a suitably designed device to be installed on most, preferably all, of the commercially available bicycle valves.

According to claim 6, the combination comprises a device, according to the invention, and a mobile indicating and/or signaling device, wherein the indicating and/or signaling device comprises transmission means for receiving the wirelessly transmitted information corresponding to the pressure and comprises indicating and/or signaling means for indicating or signaling the pressure or a change in the pressure. In this case the indicating and/or signaling device may be, in particular, a smartphone or a tablet computer.

According to claim 7, the method comprises the following process steps:

The actual pressure of the two wheeler tire is determined,

a desired pressure of the two wheeler tire is determined,

the actual pressure is compared with the desired pressure,

the actual pressure and/or the desired pressure and/or the difference between the desired pressure and the actual pressure of the two wheeler tire is/are indicated or signaled.

By indicating or signaling the actual pressure and/or the desired pressure and/or the difference between the desired pressure and the actual pressure, the deviations of the actual pressure from a desired pressure can be pointed out to the user both at the beginning of a trip, for example, while pumping up the tires of the two wheeled vehicle, and also during the trip. Furthermore, by determining the desired value it is possible to use a situation-specific desired pressure, which may possibly result in a more effective monitoring of the pressure of the tire of the two wheeled vehicle than a standard desired pressure, specified by the manufacturer of the two wheeler tire.

There is the possibility that the method can be carried out as a computer program, in particular, as an application software (app), on a mobile terminal device, such as a smartphone or a tablet computer.

It may be provided that data, which correspond to the desired pressure or which make it possible to determine the desired pressure, are retrieved from a database. A database of this type could be stored on a mobile terminal device that is used by the user. However, such a database could also be stored on a computing device that can be accessed over the internet, where in this case an application software, which is operated on the mobile terminal device, can read data out of the database over the internet. Such a database can be used to store information about the standard desired pressure levels of a plurality of different tires of two wheeled vehicles.

There is the possibility that information provided by the user can be used to determine the desired pressure. In this case the information provided by the user can relate to the weight of the rider and/or the weight of additional loads and/or the route profile of the distance to be covered and/or the two wheeled vehicle and/or the tire of the two wheeled vehicle. In this way a desired pressure, which is adapted to the specific information, can be detected.

In this respect it may be provided that the user is requested to provide the information. Thus, when the application software starts on the mobile terminal device, the user may be requested to give the missing information that is needed to calculate a desired pressure.

The desired pressure can be determined, in particular, can be calculated from the information, provided by the user, and/or the information, retrieved from the database.

There is the possibility that the actual pressure is determined by the sensor means, which are connected, in particular, to the valve of the tire of the two wheeled vehicle or to a pump for pumping up the tire of the two wheeled vehicle or are integrated into the valve of the tire of the two wheeled vehicle or into the pump for pumping up the tire of the two wheeled vehicle, where in this case preferably a device, according to the invention, is used. For example, the sensor means may be connected wirelessly, in particular, according to a Bluetooth standard, to the mobile terminal device, so that the actual pressure is transmitted to the application software.

It can be provided that the actual pressure and/or the desired pressure is/are indicated on a display, for example, the display of a mobile terminal device, such as a smartphone or a tablet computer. There is also the possibility that the difference between the desired pressure and the actual pressure is indicated.

Furthermore, there is the possibility that the desired pressure and/or the actual pressure and/or the difference between the desired pressure and the actual pressure of the tire is/are indicated or signaled during a pumping up process. In this way the user is put into a position that allows him to pump up the tire until the desired pressure is reached.

As an alternative or in addition, it may be provided that the desired pressure and/or the actual pressure and/or the difference between the desired pressure and the actual pressure of the tire can be indicated or signaled during a trip. In particular, in the event of a significant drop in pressure the user can be warned that one of the tires threatens to become flat.

In addition, there is the possibility that the actual pressure in an auxiliary container is detected, where in this case the actual pressure in the auxiliary container can be indicated or signaled. Thus, the user can carry, as an auxiliary container, a compressed air cartridge, the pressure of which can be determined in accordance with the method and can be indicated, as desired.

Claim 13 provides that the computing device, in particular, a mobile terminal device, such as a smartphone or a tablet computer, is configured to carry out a method of the invention.

Claim 14 provides that the computer program causes a computing device, in particular, a mobile terminal device, such as a smartphone or a tablet computer, to carry out the steps of a method of the invention, when said method is carried out on the computing device.

### BRIEF DESCRIPTION OF THE DRAWINGS

Other features and advantages of the present invention will become apparent from the following description of some preferred exemplary embodiments with reference to the accompanying drawings. The drawings show in:

FIG. 1 is a side view of a device according to the invention;

FIG. 2 is an enlarged sectional view according to the arrows II-II in FIG. 1;

FIG. 3 is a side view of a detail of a bicycle tire with the device from FIG. 1 and an air pump;

FIG. 4 is a sectional view of the bicycle tire, the device and the air pump from FIG. 4;

FIG. 5 is a detail view according to arrow V in FIG. 4.

### DETAILED DESCRIPTION

The same or functionally identical parts are provided with the same reference numerals in the figures.

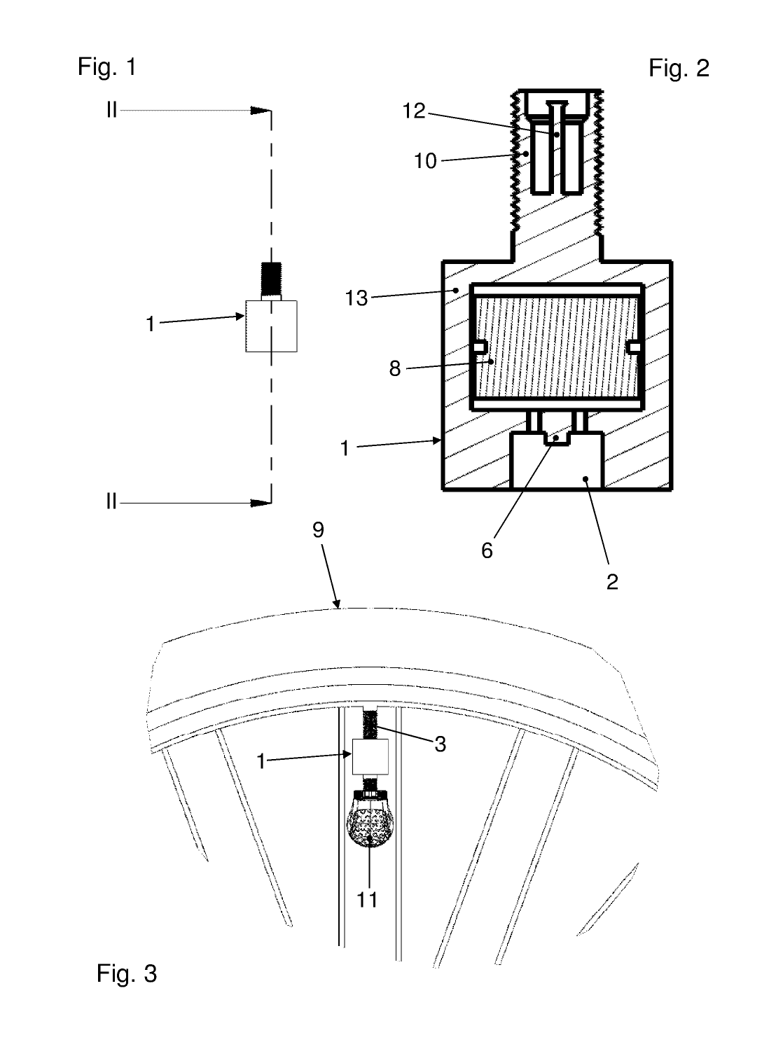

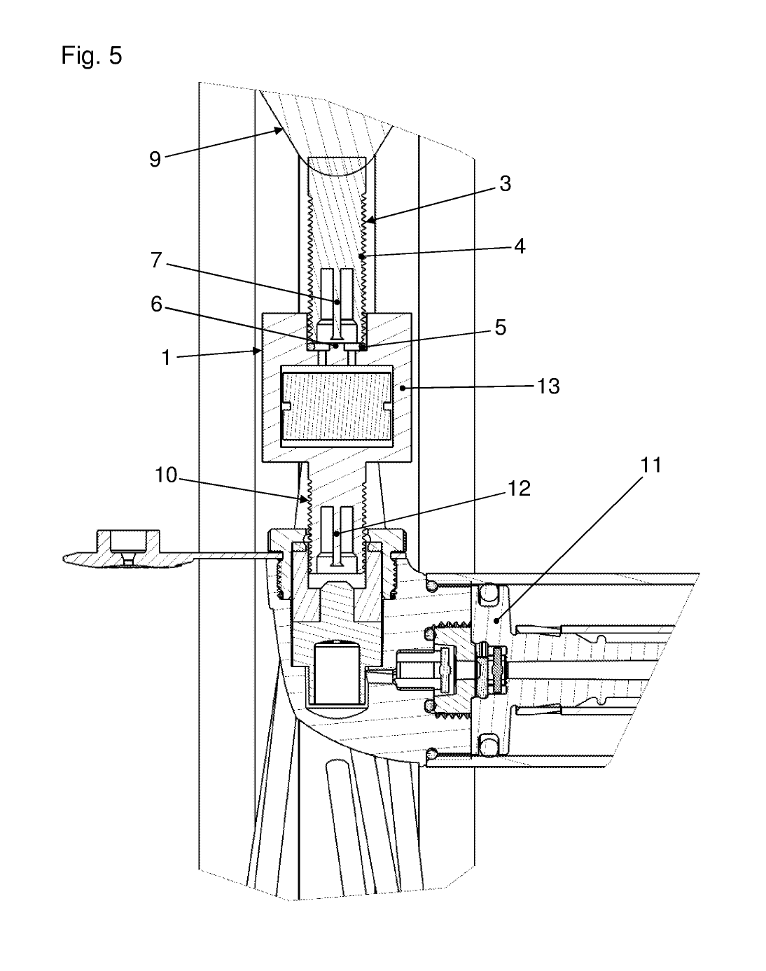

FIG. 1 and FIG. 2 show an embodiment of a device 1 of the invention that comprises a housing 13 having a recess 2 on the bottom side shown in FIG. 2. The recess 2 has an internal thread (not depicted), which can be screwed onto the external thread 4 of a valve 3 of a bicycle tire 9 (see FIG. 5). The recess 2 with an internal thread is used as the connecting means for the connection to the valve 3.

Furthermore, sealing means 5 in the form of an O-ring are provided in the recess 2; and said O-ring can rest on the face side of a valve 3. Furthermore, in the depicted embodiment of a device 1 according to the invention, a projection 6 is arranged in the recess 2; and said projection can press in a pin 7, which is provided in a valve 3, designed as a Schrader valve. By pressing in this pin 7, the valve 3 opens in a manner that is well-known.

In FIG. 5 the projection 6 and the pin 7 are shown with a small distance, shown between them for the sake of clarity. Owing to this distance the valve 3 is not yet open. Only after the internal thread has been screwed further onto the external thread 4 of the valve 3 does the projection 6 push the pin 7 a little ways into the valve 3, so that said valve is opened. In this way, the projection 6 is used, in particular, together with the internal thread of the recess 2, as the means for opening the valve 3.

Thus, the depicted embodiment of a device 1 of the invention is designed to interact with a Schrader valve. Of course, there is also the possibility of providing embodiments for other typical bicycle valves, such as Sclaverand valves and Dunlop valves. For example, in the case of Sclaverand valves a comparable projection presses in the pin, which is also provided in the Sclaverand valve, in order to open the valve.

Furthermore, the device 1 comprises a unit 8 (shown only in schematic form), which has pressure measuring means and is in fluid connection with the recess 2, in about the center region of the housing 13. This unit can be used by the pressure measuring means to measure the pressure in the recess 2. On opening the valve 3, this pressure in the recess 2 corresponds to the pressure in the bicycle tire 9, so that on suitably connecting the device 1 to the valve 3, the pressure measuring means can measure the pressure in the bicycle tire.

Furthermore, the unit 8 comprises transmission means, which can transmit in a wireless manner the information corresponding to the measured pressure. In particular, said transmission means are wireless transmission means that are suitable for a wireless transmission in accordance with a Bluetooth standard. Information about the magnitude of the pressure may be transmitted, for example, to a smartphone or a tablet computer by the transmission means. Then the pressure can be indicated to the user on said smartphone or tablet computer; or, in the event of a deviation from a desired value, said user may be signaled by means of visual or audible cues that there is a deviation.

There is, of course, the possibility of providing other transmission means that use a different transmission standard.

On the side opposite the recess 2, the device 1 has attachment means 10 for an air pump 11. In FIG. 2 the attachment means 10 project upwards beyond the housing 13 and are designed as a valve of a bicycle, in the depicted exemplary embodiment, in particular, as a Schrader valve. This means that a pin 12 is provided in the interior of the attachment means 10; and by pressing in said pin, a fluid connection to the interior of the air pump 11 can be produced.

Of course, there is also the possibility of designing the attachment means 10 in such a way that they are designed as a Sclaverand valve or a Dunlop valve.

The attachment means 10 are in fluid connection with the recess 2, so that the bicycle tire 9 can be pumped up with the air pump 11 using the device 1 and the associated valve 3 (in this respect see FIG. 5).

A preferred exemplary embodiment of the device according to the invention provides that the method can be carried out on a mobile terminal device, such as a smartphone or a tablet computer, as an application software or, more specifically, an app.

A database for tire pressure levels can be provided to monitor the pressure of the tire. This database can be stored in the mobile terminal device by the app. However, there is also the possibility that the database can be accessed by the mobile terminal device over the internet. The pressure levels of almost any type of known tire can be stored in the database.

Furthermore, the app can be designed in such a way that it can carry out a query and in this way can obtain from the user information about the two wheeled vehicle and the tires mounted thereon. For example, it can be clarified whether the two wheeled vehicle is a bicycle without an electric motor or an e-bike. Additional information may relate to the weight of the user and the weight of any piece of baggage that the user may have brought along with him. Furthermore, information about the route profile of the distance to be covered may be queried. It is also possible to learn whether the bike is carrying a compressed air cartridge or what the fill level of said compressed air cartridge is. Even the presence of an air pump can be determined.

With the aid of the information that is determined the app calculates a desired pressure of the tires by making use of the database and then indicates said desired pressure. In this case the user can pump up the tires, for example, using an air pump with a manometer, until the actual pressure corresponds to the desired pressure.

An air pump with an integrated pressure sensor may be used, instead of an air pump with a manometer. There are embodiments of such pumps that are connected, for example, by means of a wireless connection to the mobile terminal device in accordance with a Bluetooth standard and can transmit in this way the actual pressure to the application software. When the actual pressure reaches the desired pressure while pumping up the tires, this desired pressure can then be signaled, for example, by means of visual or auditory cues, to the user of the mobile terminal device.

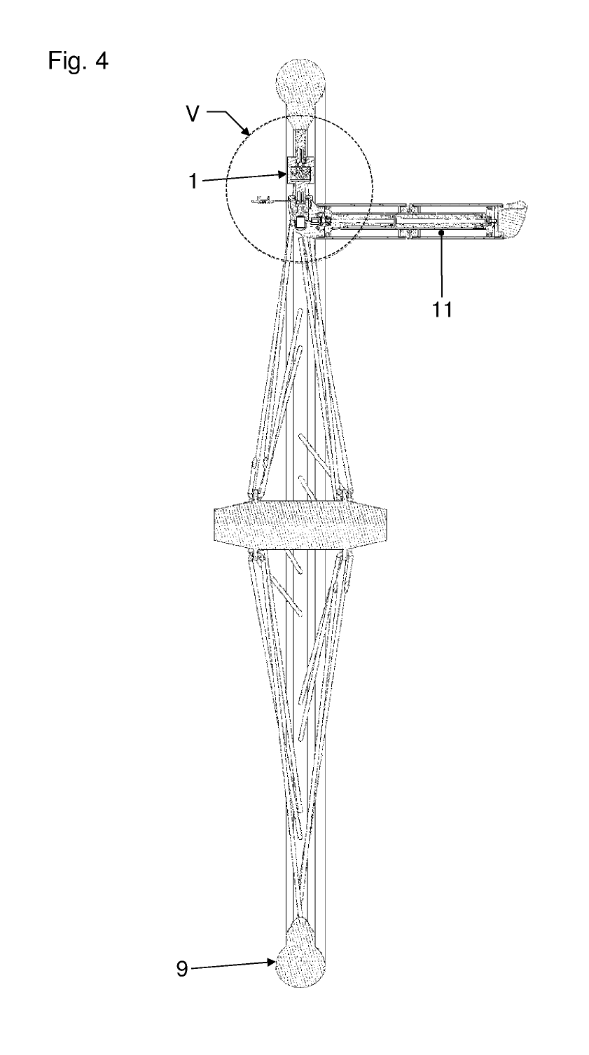

As an alternative or in addition to the air pressure sensors that are connected directly or indirectly to air pumps, an air pressure sensor can also be integrated into the valve of the tire or can be connected to the valve of the tire. In particular, a device, which is shown, for example, in FIG. 1 to FIG. 5, can be provided that can transmit wirelessly information about the air pressure to the mobile terminal device.

In this way it is also possible to monitor the air pressure during the trip. If during the trip the app determines a slow loss of air, which makes the risk of a flat tire seem probable, said app then signals this to the user and/or shows it on the display of the mobile terminal device.

Having detected the air loss, the app can inform the user that he can avail himself to a compressed air cartridge, which the bike is carrying and which has a sufficient air supply to replace the missing air.

1. A device for measuring the pressure of a two wheeler tire, comprising:
a connector to connect the device to a valve of the two wheeler tire;
a valve opener to open the valve, so that in the connected state with the valve, pressurized air flows out of the two wheeler tire through the valve into the device, until the pressure in the device corresponds to the pressure in the two wheeler tire;
a pressure measurement device to measure the pressure in the device; and
a transmitter to wirelessly transmit information corresponding to the measured pressure.

2. The device as claimed in claim 1, wherein the transmitter is suitable for a wireless transmission in accordance with a Bluetooth standard.

3. The device as claimed in claim 1, wherein the device has an attachment for an air pump on the side facing away from the connector, so that the two wheeler tire can be pumped up with the air pump by the device and the valve connected to said device, wherein the attachment for the air pump is designed as a Schrader valve and/or a Sclaverand valve and/or a Dunlop valve.

4. The device as claimed in claim 1, wherein the connector is suitable for a connection to Schrader valves and/or Sclaverand valves and/or Dunlop valves, wherein the connector has a thread for a screw connection of the device to the valve.

5. The device as claimed in claim 1, wherein the valve opener is suitable for opening Schrader valves and/or Sclaverand valves and/or Dunlop valves.

6. An assembly, comprising:
the device of claim 1; and
a mobile device comprising: a receiver to receive wirelessly transmitted information, corresponding to the pressure; and an indicator to indicate the pressure or a change in pressure.

7. A method for monitoring the pressure of a two wheeler tire, comprising:
determining an actual pressure of the two wheeler tire;
determining a desired pressure of the two wheeler tire;
comparing the actual pressure with the desired pressure; and
indicating the actual pressure and/or the desired pressure and/or the difference between the desired pressure and the actual pressure of the two wheeler tire.

8. The method, as claimed in claim 7, further comprising:
retrieving from a database information that corresponds to the desired pressure or makes it possible to determine the desired pressure; or
using information provided by the user to determine the desired pressure, wherein the information provided by the user relates to at least one of: the weight of the rider, the weight of additional loads, the route profile of distance to be covered, the two wheeled vehicle, and the tire of the two wheeled vehicle.

9. The method, as claimed in claim 8, wherein the desired pressure is calculated from the information provided by the user or the information retrieved from the database.

10. The method, as claimed in claim 7, wherein the actual pressure is determined by a sensor connected to the valve of the tire of the two wheeled vehicle or to a pump for pumping up the tire of the two wheeled vehicle or is integrated into the valve of the tire of the two wheeled vehicle or into the pump for pumping up the tire of the two wheeled vehicle.

11. The method, as claimed in claim 7, wherein during a pumping up process and/or during a trip, the desired pressure and/or the actual pressure and/or the difference between the desired pressure and the actual pressure of the tire of the two wheeled vehicle is/are indicated on a display.

12. The method, as claimed in claim 7, wherein the method is carried out as a computer program.

13-15. (canceled)
